(19) United States
(12) Patent Application Publication
(10) Pub. No.: US 2026/0322090 A1
(43) Pub. Date: Oct. 15, 2026

(54) CABLE ORGANIZER AND POWER CONNECTOR

(71) Applicant: BIZLINK INTERNATIONAL CORP., New Taipei City (TW)

(72) Inventors: Chubei ZHANG, New Taipei City (TW); Xiangwu WANG, New Taipei City (TW); Pengfei MAO, New Taipei City (TW)

(21) Appl. No.: 19/646,628

(22) Filed: Apr. 14, 2026

(30) Foreign Application Priority Data
Apr. 15, 2025 (CN) 202520704921.X

(51) Int. Cl. H02G 3/30

(52) U.S. Cl. CPC H02G 3/30

(57) ABSTRACT

A power connector includes a connector housing and a cable organizer. The connector housing receives a plurality of terminals. The cable organizer includes a conductive member and an insulating housing. The conductive member includes a main body having an input end and a plurality of output ends electrically connected to a subset of the plurality of terminals respectively. The insulating housing is molded around the main body and includes a plurality of partitions defining a plurality of cable receiving regions. The output ends of the conductive member are disposed in a subset of the plurality of cable receiving regions respectively, and each of the cable receiving regions corresponds to a respective one of the plurality of terminals.

### CROSS-REFERENCE TO RELATED APPLICATION

This application claims priority to China Application Serial Number 202520704921.X, filed on Apr. 15, 2025, which is herein incorporated by reference in its entirety.

### BACKGROUND

### Field of Invention

The present disclosure relates to the technical field of plugs. More particularly, the present disclosure relates to a cable organizer.

### Description of Related Art

A high-current electric power plug contains one ground cable, and multiple sets of live cables and neutral cables. Referring to FIG. 1, due to the limited number of the core cables 11 in the main line 1, the core cable(s) 11 in the main line 1 need(s) to be connected to multiple secondary cables 2 such that the main line 1 is connected to a sufficient number of terminals in order to meet electrical requirements. For example, if a five-core main line is to be connected to seven terminals to achieve an arrangement of one ground cable and three sets of live cables and neutral cables, one of the core cables 11 needs to be connected to the connection terminals of three secondary cables 2.

The existing connection methods are as follows. As shown in FIG. 1, the end of the core cable 11 is stripped to expose about 2 mm of the conductive core. Then, the stripped ends of the three secondary cables 2 are placed onto the exposed portion of the core cable 11, and an electrical connection process is conducted. Alternatively, as shown in FIG. 2, each of all the core cables of the main line 1 is connected to a respective terminal. Then, a first exposed core portion is formed on one of the core cables 11, and a second exposed core portion is formed on a secondary cable 2. The second exposed core portion is placed onto the first exposed core portion, and an electrical connection process is conducted. Then, each of two ends of the secondary cable 2 is connected to a respective terminal.

The disadvantages of the existing connection methods are as follows. The outer diameter of the cable connection portion includes the sum of the dimensions of multiple conductive cables. Since a high current cable is typically thicker, the outer diameter of the cable connection portion is excessively large. In the subsequent process in which the plastic portion of the plug is injection molded, the problem of exposed cable is likely to occur (i.e., the conductive cables are exposed through the edge of the plastic portion and are not properly covered), resulting in product defects.

### SUMMARY

The present disclosure provides a cable organizer which may reduce the outer diameter of the cable connection portion and prevent the problem of exposed cable during the injection molding process of the plastic portion of the plug product.

According to an embodiment of the disclosure, a power connector includes a connector housing and a cable organizer. The connector housing receives a plurality of terminals. The cable organizer includes a conductive member and an insulating housing. The conductive member includes a main body having an input end and a plurality of output ends electrically connected to a subset of the plurality of terminals respectively. The insulating housing is molded around the main body and includes a plurality of partitions defining a plurality of cable receiving regions. The output ends of the conductive member are disposed in a subset of the plurality of cable receiving regions respectively, and each of the cable receiving regions corresponds to a respective one of the plurality of terminals.

According to an embodiment of the disclosure, a cable organizer includes a conductive member and an insulating housing. The conductive member includes a main body having a cable connection end and a plurality of terminal connections ends. The insulating housing is molded around the main body and includes a plurality of partitions defining a plurality of cable receiving regions. The terminal connection ends of the conductive member are disposed in a subset of the plurality of cable receiving regions respectively, and each of the cable receiving regions is configured to correspond to a terminal.

### BRIEF DESCRIPTION OF THE DRAWINGS

FIG. 1 illustrates a schematic of the connection of an existing main line;

FIG. 2 illustrates another schematic of the connection of an existing main line;

FIG. 3 is a perspective view of the structure of the present disclosure;

FIG. 4 is a back view of the structure of the present disclosure;

FIG. 5 is a perspective view of the connection between the conductive member and the terminals;

FIG. 6 is a perspective view of the conductive member;

FIG. 7 is a side view of the conductive member;

FIG. 8 is a perspective view of the insulating housing;

FIG. 9 is a front view of the insulating housing; and

FIG. 10 is a front view of the power connector.

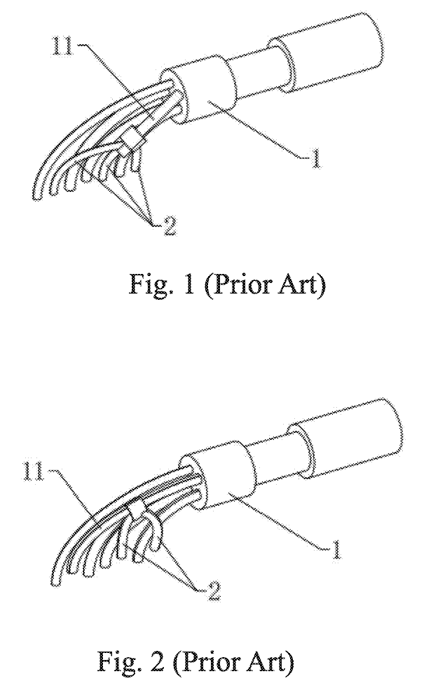

### DETAILED DESCRIPTION

To further explain the technical solution of the present disclosure, the present disclosure will be described in detail with reference to the accompanying drawings and specific embodiments.

In the description of the embodiments of the present disclosure, it should be understood that the indicated orientations or positional relationships are based on orientations or positional relationships shown in the drawings, or based on orientations or positional relationships in which the product of the present disclosure is typically placed in use, or based on orientations or positional relationships commonly understood by those skilled in the art. The indicated orientations or positional relationships are provided solely for the convenience of describing the present disclosure and for simplifying the description, and are not intended to indicate or imply that the devices or components as mentioned are required to be oriented in a specific orientation or to be constructed and operated in a specific orientation. Therefore, the indicated orientations or positional relationships should not be understood as a limitation on the present disclosure.

Furthermore, terms such as “first,” “second,” and “third” are used solely for descriptive purposes and should not be understood as indicating or implying relative importance or as specifying the quantity of the indicated technical features. Accordingly, features defined as “first” or “second” may explicitly or implicitly include one or more of said features.

In the description of the present disclosure, “a plurality” means two or more, unless otherwise explicitly specified. A first end of a component is closer to the input end with respect to a second end of the component. The second end of the component is closer to the output end with respect to the first end of the component. The first end is opposite to the second end. The top direction refers to a direction in which the openings of the cable receiving regions 42 face. The bottom direction refers to a direction that is opposite to the top direction.

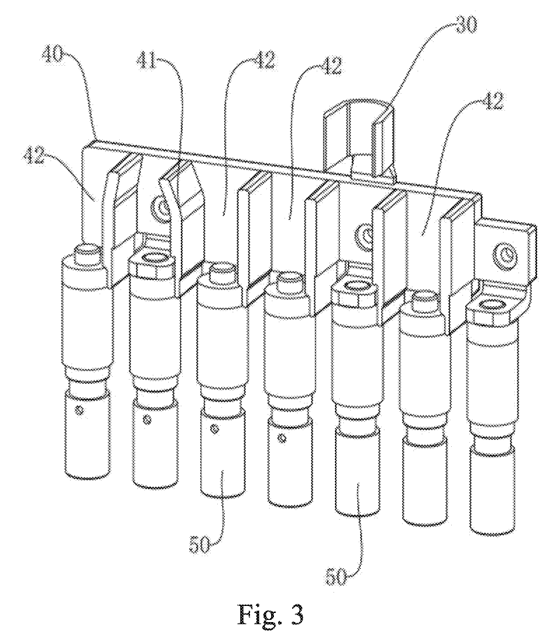

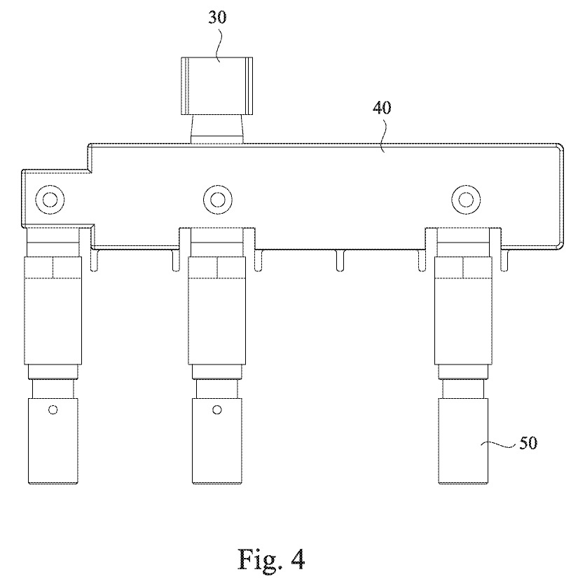

As shown in FIGS. 3, 4 and 5, the present disclosure provides a cable organizer, which includes a conductive member 30, an insulating housing 40, and a plurality of terminals 50. The conductive member 30 includes a main body 31. The main body 31 is provided with an input end on one side and three output ends on another side. However, the quantity of the output ends is not limited to three. Three terminals 50 among the plurality of terminals 50 are connected respectively to the three output ends of the conductive member 30. The insulating housing 40 is molded around the main body 31 through injection molding. The insulating housing 40 is provided with a plurality of partitions 41 through which a plurality of cable receiving regions 42 are defined on the insulating housing 40. Each of the output ends of the conductive member 30 is disposed in a corresponding cable receiving region 42. Each of the plurality of cable receiving regions 42 corresponds to a respective one of the plurality of terminals 50. The plurality of terminals 50 are located respectively at second ends of the cable receiving regions 42. The input end may also be referred to as cable connection end, and the output ends may also be referred to as terminal connection ends.

The present disclosure utilizes a conductive member 30 which leads out multiple output ends, such that the conductive member 30, in replacement of an existing secondary cable, can be connected directly to the terminals 50. Then, the insulating housing 40 is molded around the conductive member 30 through injection molding and forms cable receiving regions 42, thereby ensuring galvanic isolation between the plurality of terminals 50. In use, a core cable in the main line that is to be connected to multiple terminals 50 is stripped and forms an exposed core portion. Then, the exposed core portion is electrically connected to the input end of the conductive member 30. By doing so, the electrical connection between the core cable and the multiple terminals 50 is established. As for other core cables in the main line, each of them can be connected directly to a respective terminal 50 through a respective cable receiving region 42. The structure of the present disclosure may effectively reduce the outer diameter of the cable connection portion, prevent the problem of exposed cable during the injection molding of the plastic portion of the plug product, and effectively isolate each of the connection terminals 50.

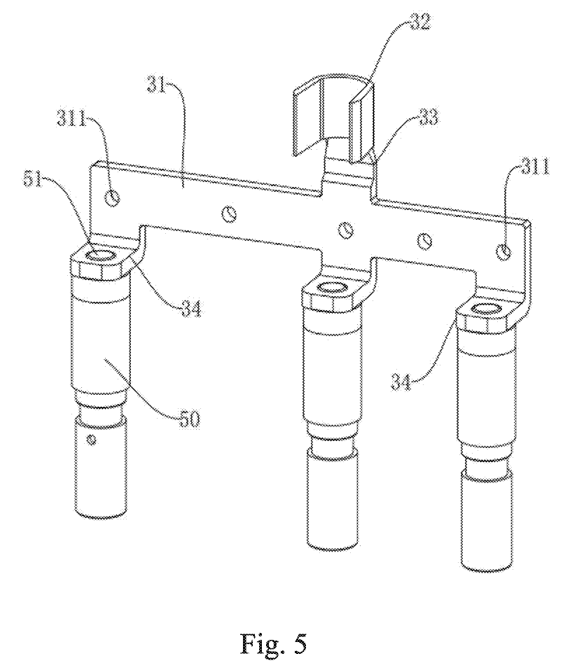

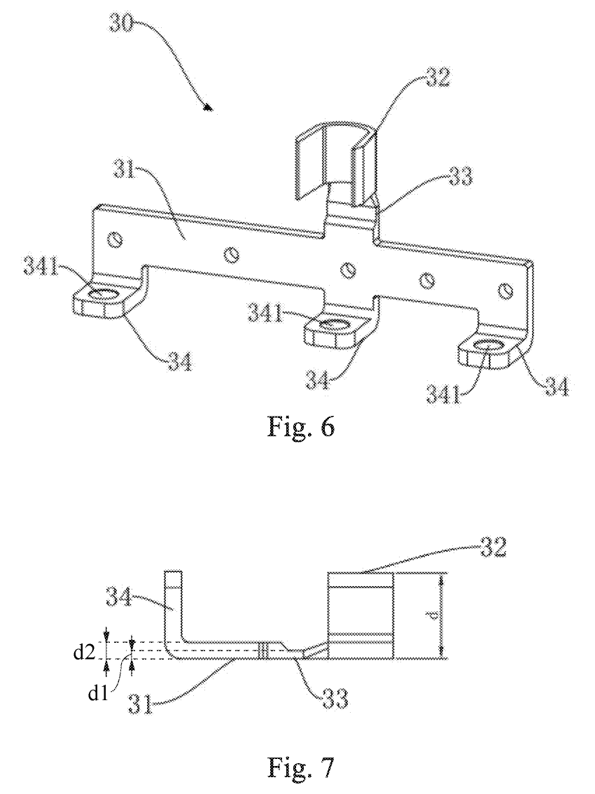

As shown in FIGS. 5-7, in the embodiment of the present disclosure, a maximum thickness of the input end is from about 2 mm to about 40 mm. The input end includes a U-shaped groove 32 and a connecting portion 33. The U-shaped groove 32 is connected to the main body 31 through the connecting portion 33. An opening of the U-shaped groove 32 and openings of the plurality of cable receiving regions 42 face a same direction. Specifically, the connecting portion 33 has a first end connected to the U-shaped groove 32 and a second end connected to the main body 31. The first end matches a shape of a groove bottom defined in the U-shaped groove 32. A thickness of the first end is less than a thickness of the second end such that a step is defined on a top surface of the connecting portion 33. A top surface of the second end is flush with a top surface of the main body 31 and a bottom surface of the second end is flush with a bottom surface of the main body 31. The U-shaped groove 32 supports the main line and provides a wiring point for the core cable that is to be connected to multiple terminals 50. The main line may be placed in the U-shaped groove 32, and the core cable that is to be connected to multiple terminals 50 is identified and stripped to form an exposed core portion. The exposed core portion is electrically connected to the U-shaped groove 32 or the connecting portion 33.

As shown in FIG. 7, a ratio of the thickness d1 of the first end to the thickness d2 of the second end is about 0.5. In some embodiments of the present disclosure, a ratio of the thickness d1 of the first end to the thickness d2 of the second end is 0.45-0.55.

The output ends include connecting plates 34. The connecting plates 34 are connected to a top portion of the main body 31 and are perpendicular to the main body 31. Each of the connecting plates 34 is provided with a connecting hole 341. Correspondingly, each of the terminals 50 is provided with a connecting post 51 at an end where the terminal is connected to the connecting plate 34. Each of the connecting holes 341 matches a corresponding one of the connecting posts 51. Each of the connecting plates 34 needs to be electrically connected to a corresponding terminal 50, and the provision of the connecting holes 341 and the connecting posts 51 allows for easier connection between the connecting plates 34 and the terminals 50.

The main body 31 is provided with through holes 311 each located at a position corresponding to a respective one of the output ends. The through holes 311 are exposed from the insulating housing 40. The input end, one of the output ends, and one cable receiving region 42 which corresponds to the one of the output ends are linearly aligned along a horizontal line. As such, the core cable that is to be connected to multiple terminals 50 may also be electrically connected to the conductive member 30 via the through holes 311.

In the embodiment of the present disclosure, the main line may be connected to the U-shaped groove 32 by way of a rivet, and the connection between the connecting plates 34 and the terminals 50 may be established through welding, soldering, brazing, or a rivet structure.

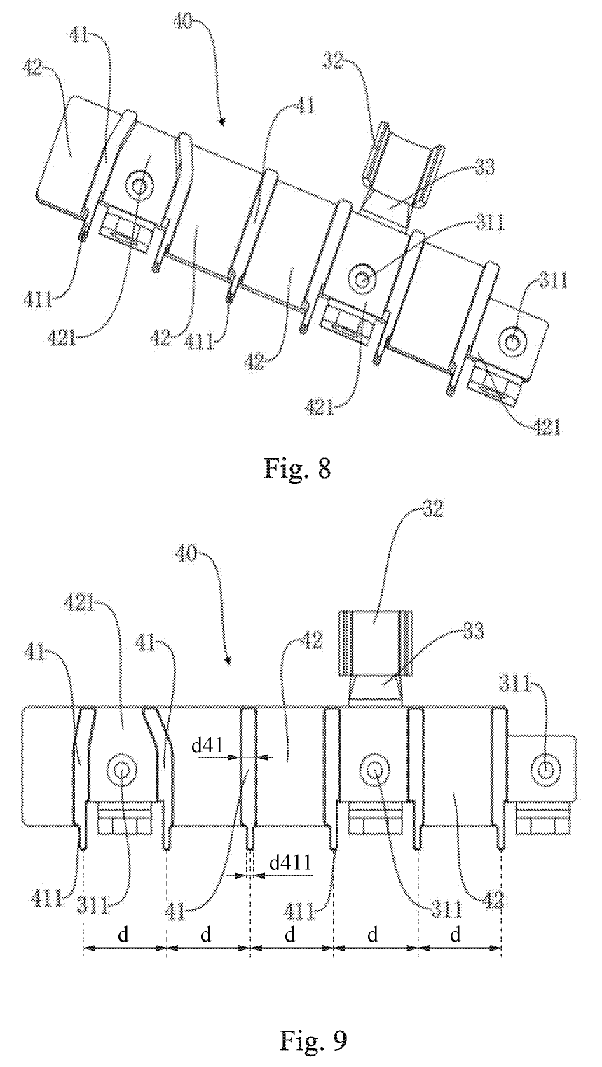

As shown in FIGS. 8 and 9, each of the partitions 41 has a first end and a second end, and the second end is further from the input end than the first end. The insulating housing 40 has a body. Each of the second ends of the plurality of partitions 41 of the insulating housing 40 is provided with an extension portion 411 which extends beyond the body of the insulating housing 40. A thickness of each extension portion 411 is less than a thickness of the corresponding partition 41 such that steps are formed on opposite sides of the partition 41 where the partition meets the extension portion 411.

As shown in FIG. 9, a ratio of the thickness d411 of the extension portion 411 to the thickness d41 of the partition 41 is about 0.4. In some embodiments of the present disclosure, a ratio of the thickness d411 of the extension portion 411 to the thickness d41 of the partition 41 is 0.36-0.44.

As shown in FIG. 9, center-to-center distances d are defined between adjacent extension portions 411, and adjacent extension portions 411 are arranged at equal intervals.

Cable receiving regions 42 which correspond respectively to the output ends are defined as first cable receiving regions 421. The first ends of two partitions 41 defining one of the first cable receiving regions 421 are inclined inward toward each other to form a V-shaped structure. At least one of the first cable receiving regions 421 is defined by such a V-shape structure. In the embodiment, the insulating housing 40 is provided with seven cable receiving regions 42, the seven cable receiving regions 42 include three first cable receiving regions 421, and the three first cable receiving regions 421 are located respectively at second, fifth, and seventh locations from left to right. The cable receiving regions 42 located at second to sixth locations are defined by two partitions 41 respectively.

In some embodiments of the present disclosure, the cable receiving regions 42 include first cable receiving regions 421 and second cable receiving regions. The output ends are disposed respectively in the first cable receiving regions 421. As the cable that is to be connected to multiple terminals 50 is electrically connected to the conductive member 30 through the input end, the first cable receiving regions 421 do not receive any cable. Each of the second cable receiving regions receives a cable.

One output end is located at an edge of the insulating housing 40. Each of the cable receiving regions 42 has a first end and a second end, and the second end is further from the input end than the first end. The first end of one cable receiving region 42 which corresponds to the one output end is recessed towards the second end of the one cable receiving region 42 and forms a stepped structure.

In some embodiments of the present disclosure, each of the cable receiving regions 42 has a first end and a second end, and the second end is further from the input end than the first end. Each of the second ends of cable receiving regions 42 which correspond respectively to the output ends is recessed towards a respective one of the first ends of the cable receiving regions 42 which correspond respectively to the output ends.

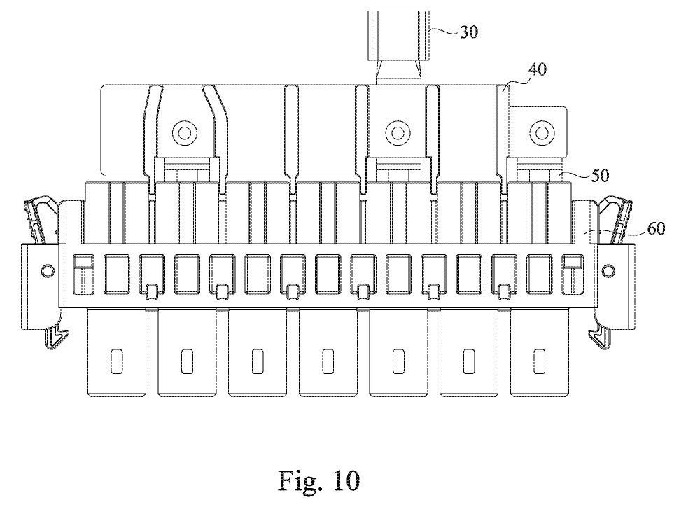

As shown in FIG. 10, the cable organizer of the present disclosure may be used in a power connector. The power connector includes a connector housing 60 and a cable organizer. The connector housing 60 includes a plurality of receiving portions. The cable organizer includes a conductive member 30 and an insulating housing 40. Each of the receiving portions receives a terminal 50. Each of the plurality of cable receiving regions 42 (see FIG. 9) is expanded from its first end towards its second ends. Each of the receiving portions matches a respective one of the second ends of the cable receiving regions 42. The power connector further includes a plurality of cables (not shown). The connections of the cables are as previously described. The power connector can be molded into a plug product.

In conclusion, the present disclosure utilizes a conductive member 30 which leads out multiple output ends, such that the conductive member 30, in replacement of an existing secondary cable, can be connected directly to the terminals 50. Then, the insulating housing 40 is molded around the conductive member 30 through injection molding and forms cable receiving regions 42, thereby ensuring galvanic isolation between the plurality of terminals 50. The present disclosure may effectively reduce the outer diameter of the cable connection portion, prevent the problem of exposed cable during the injection molding of the plastic portion of the plug product, and effectively isolate each of the connection terminals 50.

The foregoing outlines the embodiments of the present disclosure, and should not be construed as limiting the scope of the present invention. Therefore, any minor variations, equivalent changes, and modifications made to the above embodiments based on the technical essence of the invention shall still fall within the scope of the invention.

What is claimed is:

1. A power connector, comprising:
a connector housing receiving a plurality of terminals; and
a cable organizer, comprising:
a conductive member comprising a main body having an input end and a plurality of output ends electrically connected to a subset of the plurality of terminals respectively; and
an insulating housing, molded around the main body and comprising a plurality of partitions defining a plurality of cable receiving regions;
wherein the output ends of the conductive member are disposed in a subset of the plurality of cable receiving regions respectively, and each of the cable receiving regions corresponds to a respective one of the plurality of terminals.

2. The power connector of claim 1, wherein the input end comprises a U-shaped groove and a connecting portion, the U-shaped groove is connected to the main body through the connecting portion, and an opening of the U-shaped groove and openings of the plurality of cable receiving regions face a same direction.

3. The power connector of claim 2, wherein the connecting portion has a first end connected to the U-shaped groove and a second end connected to the main body, and a thickness of the first end is less than a thickness of the second end such that a step is defined on a top surface of the connecting portion; and
wherein a top surface of the second end is flush with a top surface of the main body and a bottom surface of the second end is flush with a bottom surface of the main body.

4. The power connector of claim 3, wherein a ratio of the thickness of the first end to the thickness of the second end is 0.45-0.55.

5. The power connector of claim 1, wherein the output ends comprise connecting plates extending from the main body and perpendicular to the main body.

6. The power connector of claim 5, wherein each of the connecting plates is provided with a connecting hole, each of the terminals is provided with a connecting post at an end where the terminal is connected to the connecting plate, and each of the connecting holes matches a corresponding one of the connecting posts.

7. The power connector of claim 1, wherein the main body is provided with through holes each located at a position corresponding to a respective one of the plurality of output ends, and the through holes are exposed from the insulating housing.

8. The power connector of claim 1, wherein the input end, one of the output ends, and one of the plurality of cable receiving regions which corresponds to the one of the output ends are linearly aligned along a horizontal line, and a maximum thickness of the input end is from about 2 mm to about 40 mm.

9. The power connector of claim 1, wherein each of the plurality of partitions has a first end and a second end, the second end is further from the input end than the first end, the insulating housing has a body, and each of the second ends of the plurality of partitions is provided with an extension portion which extends beyond the body of the insulating housing.

10. The power connector of claim 9, wherein a thickness of each extension portion is less than a thickness of the corresponding partition such that steps are formed on opposite sides of the partition where the partition meets the extension portion.

11. The power connector of claim 9, wherein adjacent extension portions are arranged at equal intervals.

12. The power connector of claim 1, further comprising a plurality of cables disposed on the insulating housing.

13. The power connector of claim 12, wherein the cable receiving regions comprise first cable receiving regions and second cable receiving regions, the output ends are disposed respectively in the first cable receiving regions, the plurality of cables are disposed respectively in the second cable receiving regions, each of the plurality of partitions has a first end and a second end, the second end being further from the input end than the first end; and
the first ends of two of the plurality of partitions defining one of the first cable receiving regions are inclined inward toward each other to form a V-shaped structure.

14. The power connector of claim 1, wherein each of the plurality of cable receiving regions has a first end and a second end, the second end is further from the input end than the first end, and one of the plurality of cable receiving regions is expanded from the first end of the one of the plurality of cable receiving regions towards the second end of the one of the plurality of cable receiving regions.

15. A cable organizer, comprising:
a conductive member comprising a main body having a cable connection end and a plurality of terminal connection ends; and
an insulating housing, molded around the main body and comprising a plurality of partitions defining a plurality of cable receiving regions;
wherein the terminal connection ends of the conductive member are disposed in a subset of the plurality of cable receiving regions respectively, and each of the cable receiving regions is configured to correspond to a terminal.

16. The cable organizer of claim 15, wherein each of the plurality of partitions has a first end and a second end, the second end is further from the cable connection end than the first end, the insulating housing has a body, and each of the second ends of the plurality of partitions is provided with an extension portion which extends beyond the body of the insulating housing.

17. The cable organizer of claim 16, wherein a thickness of each extension portion is less than a thickness of the corresponding partition such that steps are formed on opposite sides of the partition where the partition meets the extension portion.

18. The cable organizer of claim 17, wherein a ratio of the thickness of the extension portion to the thickness of the partition is 0.36-0.44.

19. The cable organizer of claim 15, wherein the cable receiving regions comprise first cable receiving regions and second cable receiving regions, the terminal connection ends are disposed respectively in the first cable receiving regions, each of the second cable receiving regions is configured to receive a cable, each of the plurality of partitions has a first end and a second end, the second end is further from the cable connection end than the first end; and
the first ends of two of the plurality of partitions defining one of the first cable receiving regions are inclined inward toward each other to form a V-shaped structure.
